(19) United States
(12) Patent Application Publication
(10) Pub. No.: US 2014/0251483 A1
(43) Pub. Date: Sep. 11, 2014

(54) TUBE ASSEMBLY FOR USE IN FUEL INJECTION ASSEMBLIES AND METHODS OF ASSEMBLING SAME

(71) Applicant: GENERAL ELECTRIC COMPANY, Schenectady, NY (US)

(72) Inventors: Carl Robert Barker, Simpsonville, SC (US); Jonathan Dwight Berry, Simpsonville, SC (US)

(73) Assignee: GENERAL ELECTRIC COMPANY, Schenectady, NY (US)

(21) Appl. No.: 13/788,812

(22) Filed: Mar. 7, 2013

(51) Int. Cl. F16L 9/00

(52) U.S. Cl. CPC F16L 9/00
USPC 138/109; 29/428

(57) ABSTRACT

A tube assembly for use in a fuel injection assembly of a turbine engine is provided. The tube assembly includes a housing, and a plurality of tube assembly units positioned adjacent to one another within the housing such that each tube assembly extends along a longitudinal axis of the housing. Each tube assembly unit includes a tube, and a plurality of flanges extending radially outward from each tube, wherein flanges of adjacent tube assembly units form at least a portion of at least one wall within the housing.

### FEDERAL RESEARCH STATEMENT

This invention was made with Government support under Contract No. DE-FC26-05NT42643, awarded by the Department of Energy (DOE), and the Government has certain rights in this invention.

### BACKGROUND OF THE INVENTION

The subject matter disclosed herein relates generally to turbine engines, and more particularly, to tube assemblies for use in fuel injection assemblies.

At least some known turbine engines are used in cogeneration facilities and power plants. Such engines may have high specific work and high power-per-unit mass flow requirements. To increase the operating efficiency, at least some known turbine engines, such as gas turbine engines, may operate with increased combustion temperatures. Generally, in at least some of such known gas turbine engines, engine efficiency increases as combustion gas temperatures increase.

However, operating known turbine engines with higher temperatures may also increase the generation of polluting emissions, such as oxides of nitrogen (NO_{X}). In an attempt to reduce the generation of such emissions, at least some known turbine engines include improved combustion system designs. For example, many combustion systems may use premixing technology that include tube assemblies or micro-mixers that mix substances, such as diluents, gases, and/or air with fuel to generate a fuel mixture for combustion. Premixing technology may also allow hydrogen doping. During hydrogen doping, hydrogen gas (H₂) is mixed with fuel, prior to the mixture being channeled to fuel nozzles. Hydrogen doping has been shown to reduce emission levels and helps reduce the likelihood of combustor lean blow out (LBO), but may have limitations.

In at least some known combustion systems, a fuel injection assembly includes a tube assembly that includes at least one plenum and a plurality of tubes that extend therethrough to enable fuel to mix with air. However, for at least some known fuel injection assemblies, it may be relatively difficult to modify features of the tube assembly such as plenum size, plenum spacing, etc. Further, assembling at least some known tube assemblies may be relatively complicated, time-consuming, and/or costly.

### BRIEF DESCRIPTION OF THE INVENTION

In one aspect, a tube assembly for use in a fuel injection assembly of a turbine engine is provided. The tube assembly includes a housing, and a plurality of tube assembly units positioned adjacent to one another within the housing such that each tube assembly extends along a longitudinal axis of the housing. Each tube assembly unit includes a tube, and a plurality of flanges extending radially outward from each tube, wherein flanges of adjacent tube assembly units form at least a portion of at least one wall within the housing.

In another aspect, a tube assembly unit for use in a fuel injection assembly of a turbine engine is provided. The tube assembly unit includes a tube, and a plurality of flanges extending radially outward from the tube, wherein the plurality of flanges are configured to form at least a portion of at least one wall with flanges of adjacent tube assembly units.

In yet another aspect, a method of assembling a tube assembly for use in a fuel injection assembly of a turbine engine is provided. The method includes providing a housing, and positioning a plurality of tube assembly units adjacent to one another within the housing such that each tube assembly extends along a longitudinal axis of the housing, each tube assembly unit including a tube and a plurality of flanges extending radially outward from each tube, wherein flanges of adjacent tube assembly units form at least a portion of at least one wall within the housing.

### BRIEF DESCRIPTION OF THE DRAWINGS

FIG. 1 is a schematic cross-sectional view of an exemplary turbine engine.

FIG. 2 is a schematic cross-sectional view of a portion of an exemplary fuel injection assembly used with the turbine engine shown in FIG. 1.

FIG. 3 is a perspective view of an exemplary tube assembly that may be used with the fuel injection assembly shown in FIG. 2.

FIG. 4 is a perspective view of an exemplary tube assembly unit that may be used with the tube assembly shown in FIG. 3.

FIG. 5 is a perspective view of a portion of alternative tube assembly that may be used with the fuel injection assembly shown in FIG. 2.

### DETAILED DESCRIPTION OF THE INVENTION

The systems and methods described herein provide a tube assembly for use with a fuel injection assembly of a gas turbine engine. The tube assembly is formed from a housing and a plurality of tube assembly units. Each tube assembly unit includes a tube and a plurality of flanges. By positioning tube assembly units adjacent to each other, the flanges form at least a portion of a wall that defines plenums within the tube assembly.

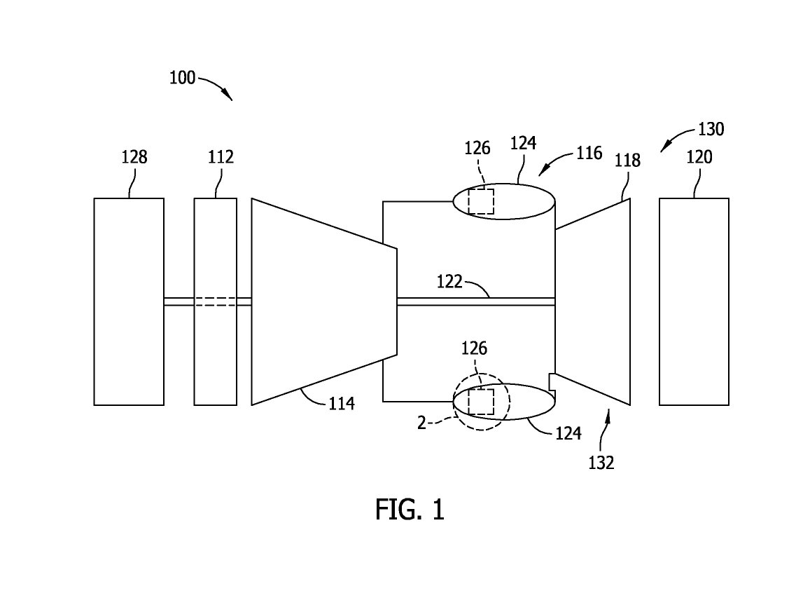

FIG. 1 is a schematic cross-sectional view of an exemplary turbine engine 100. More specifically, turbine engine 100 is a gas turbine engine. While the exemplary embodiment illustrates a gas turbine engine, the present invention is not limited to any one particular engine, and one of ordinary skill in the art will appreciate that the current invention may be used in connection with other turbine engines.

In the exemplary embodiment, turbine engine 100 includes an intake section 112, a compressor section 114 coupled downstream from intake section 112, a combustor section 116 coupled downstream from compressor section 114, a turbine section 118 coupled downstream from combustor section 116, and an exhaust section 120. Turbine section 118 is coupled to compressor section 114 via a rotor shaft 122. In the exemplary embodiment, combustor section 116 includes a plurality of combustors 124. Combustor section 116 is coupled to compressor section 114 such that each combustor 124 is in flow communication with compressor section 114. A fuel injection assembly 126 is coupled within each combustor 124. Turbine section 118 is coupled to compressor section 114 and to a load 128 such as, but not limited to, an electrical generator and/or a mechanical drive application. In the exemplary embodiment, each compressor section 114 and turbine section 118 includes at least one rotor disk assembly 130 that is coupled to a rotor shaft 122 to form a rotor assembly 132.

During operation, intake section 112 channels air towards compressor section 114 wherein the air is compressed to a higher pressure and temperature prior to being discharged towards combustor section 116. The compressed air is mixed with fuel and other fluids that are provided by each fuel injection assembly 126 and ignited to generate combustion gases that are channeled towards turbine section 118. More specifically, each fuel injection assembly 126 injects fuel, such as natural gas and/or fuel oil, air, diluents, and/or inert gases, such as Nitrogen gas (N₂), into respective combustors 124, and into the air flow. The fuel mixture is ignited to generate high temperature combustion gases that are channeled towards turbine section 118. Turbine section 118 converts the thermal energy from the gas stream to mechanical rotational energy, as the combustion gases impart rotational energy to turbine section 118 and to rotor assembly 132. Because fuel injection assembly 126 injects the fuel with air, diluents, and/or inert gases, NOx emissions may be reduced within each combustor 124.

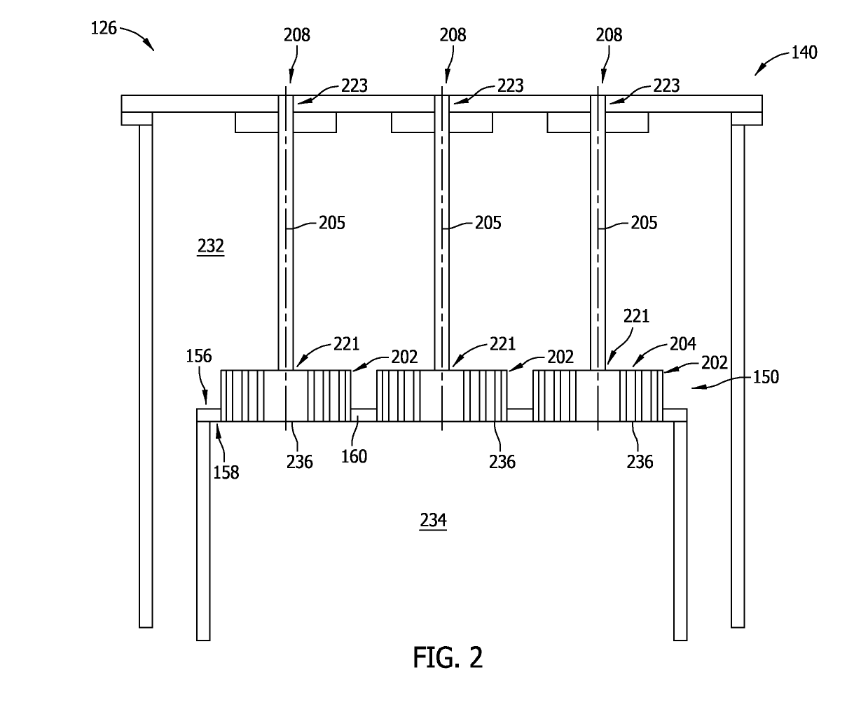

FIG. 2 is a cross-sectional view of a portion of fuel injection assembly 126 taken along area 2 (shown in FIG. 1). In the exemplary embodiment, fuel injection assembly 126 extends from an end cover 140 of combustor 124 (shown in FIG. 1). An endcap assembly 150 is downstream from end cover 140 and includes an upstream portion 156 and a downstream portion 158. In the exemplary embodiment, endcap assembly 150 also includes an end plate 160, and a plurality of tube assemblies 202 are coupled to end plate 160. Alternatively, in some embodiments, endcap assembly 150 does not include an end plate 160, and each tube assembly 202 is coupled to an adjacent tube assembly 202. In the exemplary embodiment, tube assemblies 202 are generally hexagonal, as described in detail below. Alternatively, tube assemblies 202 may have any other shape and/or size that enables fuel injection assembly 126 and/or turbine engine 100 to function as described herein.

In the exemplary embodiment, tube assemblies 202 are fuel injection nozzles that extend substantially axially to end plate 160. Each tube assembly 202 includes a plurality of tubes 204 and has a longitudinal axis 205. Tube assemblies 202 are formed integrally with end plate 160 in the exemplary embodiment. Alternatively, each tube assembly 202 may be coupled to an adjacent tube assembly 202. In the exemplary embodiment, each tube 204 discharges a mixture of fuel, air, and other fluids through a passage (not shown in FIG. 2) defined within each tube 204.

In the exemplary embodiment, fuel injection assembly 126 may include three tube assemblies 202, as shown in FIG. 2. Alternatively, fuel injection assembly 126 may include any number of tube assemblies 202 that enables fuel injection assembly 126 to function as described herein. A fuel delivery pipe 208 includes a first end portion 221 that is coupled to tube assembly 202, and a second end portion 223 that is coupled to a fuel source (not shown). In the exemplary embodiment, fuel delivery pipe 208 is generally cylindrical. Alternatively, fuel delivery pipe 208 may have any other shape and/or size that enables fuel injection assembly 126 and/or turbine engine 100 to function as described herein.

Tube assemblies 202 extend through a fluid supply chamber 232 that supplies fluid to each tube assembly 202. In the exemplary embodiment, fluid supply chamber 232 supplies air to tube assembly 202. Alternatively, fluid supply chamber 232 may supply any other fluid to tubes 204 that enables tube assembly 202 to function as described herein. Fuel injected into tubes 204 is mixed with the air in tubes 204. The fuel/air mixture exits tubes 204 at downstream portion 158 and is combusted in a combustion chamber 234. At downstream portion 158, tube assemblies 202 each include an aft plate 236. For ease of illustration, in FIG. 2, each tube assembly 202 includes a single plenum. However, and as described in more detail below, each tube assembly 202 may include any number of plenums that enable tube assemblies 202 to function as described herein.

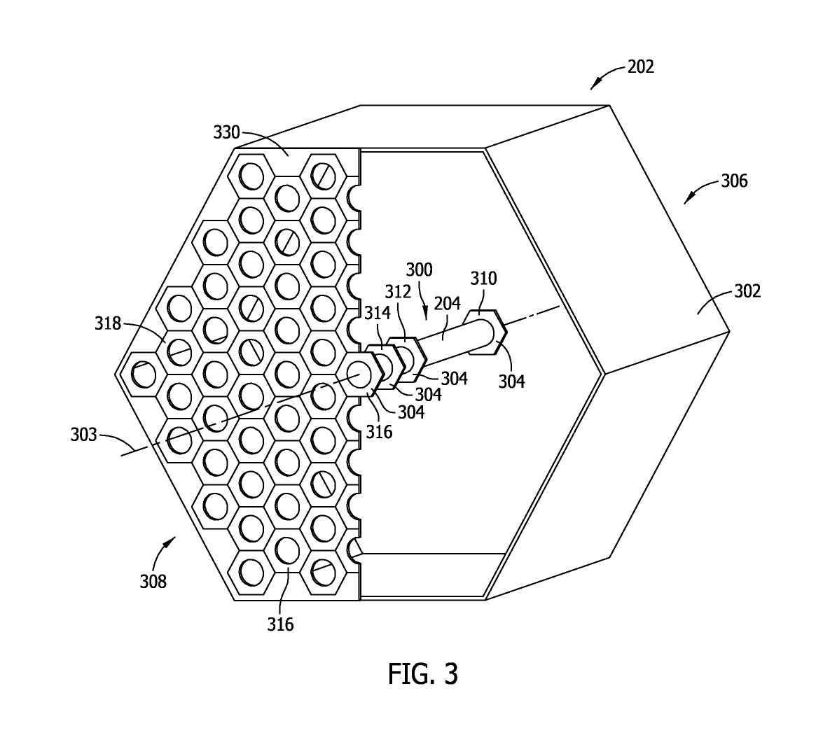

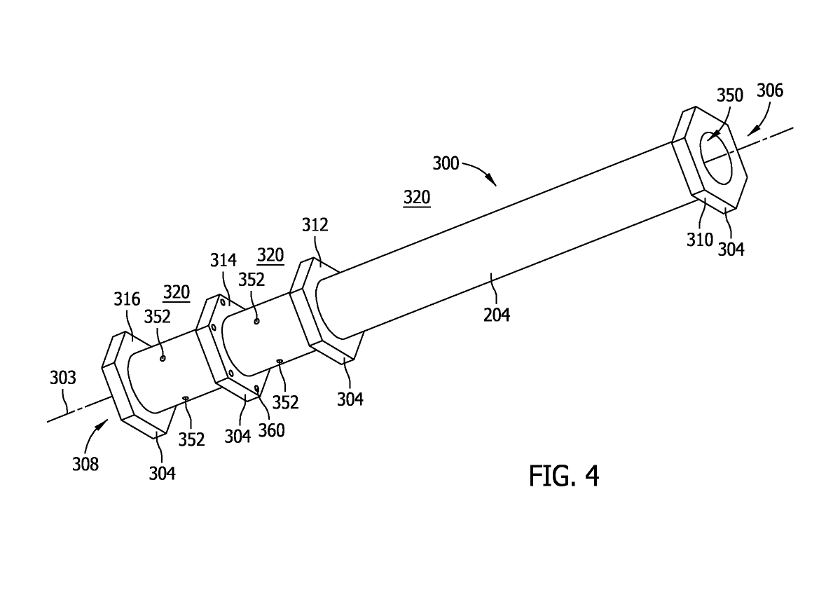

FIG. 3 is a perspective view of an exemplary tube assembly 202 that may be used with fuel injection assembly 126 (shown in FIG. 2). FIG. 4 is a perspective view of an exemplary tube assembly unit 300 that may be used with tube assembly 202 (shown in FIG. 3). In the exemplary embodiment, tube assembly 202 includes a housing 302 and a plurality of tube assembly units 300 that extend along a longitudinal axis 303 of tube assembly 202. For clarity, only one tube assembly unit 300 is illustrated in FIG. 3.

Each tube assembly unit 300 includes a tube 204 and a plurality of flanges 304 that each extend radially outward from tube 204. Tube assembly units 300 extend from an aft end 306 to a fore end 308 of tube assembly 202 in the exemplary embodiment. In the exemplary embodiment, tube assembly unit 300 includes an aft plate flange 310, a first intermediate flange 312, a second intermediate flange 314, and a fore plate flange 316. Alternatively, tube assembly unit 300 may include any number of flanges 304 that enables tube assembly 202 to function as described herein.

Flanges 304 define one or more plenums 320 in tube assembly 202 when a plurality of tube assembly units 300 are positioned adjacent to each other in housing 302. Specifically, in the exemplary embodiment, aft plate flanges 310 on a plurality of adjacent tube assembly units 300 form at least a portion of aft plate 236 (shown in FIG. 2), first intermediate flanges 312 form at least a portion of a first intermediate wall (not shown), second intermediate flanges 314 form at least a portion of a second intermediate wall (not shown), and fore plate flanges 316 form at least a portion of a fore plate 318 at first end portion 221 (shown in FIG. 2). Accordingly, a plenum 320 is defined between aft plate flanges 310 and first intermediate flanges 312, a plenum 320 is defined between first intermediate flanges 312 and second intermediate flanges 314, and a plenum 320 is defined between second intermediate flanges 314 and fore plate flanges 316. As will be understood by those skilled in the art, in other embodiments having a different number of flanges 304 than is included in the exemplary embodiment, a different number of plenums 320 will be defined in tube assembly 202.

In the exemplary embodiment, a fore plate fringe 330 extends from housing 302 substantially perpendicularly to longitudinal axis 303. Fore plate fringe 330 may be formed integrally with housing 302, or alternatively, may be coupled to housing 302 using welding or other suitable techniques. As shown in FIG. 3, fore plate fringe 330 is sized and oriented to form fore plate 318 with fore plate flanges 316 of tube assembly units 300. In at least some alternative embodiments, fore plate flanges 316 and housing 302 form fore plate 318 without a fore plate fringe 330. In the exemplary embodiment, tube assembly 202 includes an aft plate fringe, a first intermediate wall fringe, and a second intermediate wall fringe (not shown) sized and oriented to form aft plate 236, first intermediate wall, and second intermediate wall, respectively, with corresponding flanges 304.

For clarity, only a portion of fore plate 318 is illustrated in FIG. 3. Further, although FIG. 3 only shows one complete tube assembly unit 300, those of skill in the art will understand that in the exemplary embodiment, each fore plate flange 316 is part of a tube assembly unit 300. In at least some embodiments, at least a portion of aft plate 236 is formed from fore plate pieces (not shown) that are not part of an aft plate fringe or tube assembly units 300. These aft plate pieces may have any shape suitable for forming a portion of aft plate 236, and may be solid or have one or more apertures defined therethrough that enable fluid to be channeled therethrough from an aft-most plenum 320 into combustion chamber 234 (shown in FIG. 2).

In the exemplary embodiment, housing 302 and flanges 304 each have a hexagonal shape. Alternatively, housing 302 and/or flanges 304 may have any shape that enables tube assembly 202 to function as described herein. For example, housing and/or flanges 304 may be circular, square, triangular, pentagonal, or other polygonal shapes. Further, the shape of housing 302 need not match the shape of flanges 304. For example, in one embodiment, tube assembly 202 includes a cylindrical housing 302 and hexagonal flanges 304.

In the exemplary embodiment, all flanges 304 are substantially identical. Alternatively, the size and/or shape of flanges 304 may vary between tube assembly units 300 and/or vary within a particular tube assembly unit 300. For example, in one embodiment, tube assembly unit 300 may have a relatively small, square fore plate flange 316 and a relatively large, hexagonal aft plate flange 310. Accordingly, those skilled in the art will understand that flanges may have any shape and size that enables walls and plenums to be formed in tube assembly 202.

Moreover, the spacing defined between flanges 304 along longitudinal axis 303 is not limited to the spacing illustrated in FIGS. 3 and 4. Rather, the spacing between flanges 304 determines the size of plenums 320, and may be adjusted accordingly. For example, in the exemplary embodiment, plenum 320 is formed between aft plate flanges 310 and first intermediate flanges 312 is larger than the plenum 320 formed between first intermediate flanges 312 and second intermediate flanges 314, and larger than the plenum 320 formed between second intermediate flanges 314 and fore plate flanges 316.

In the exemplary embodiment, tube 204 is cylindrical and includes a fluid passage 350 defined therein. Alternatively, tube 204 may be any shape that enables tube assembly 202 to function as described herein. Tube 204 includes a plurality of apertures 352 that provide fluid communication between fluid passage 350 and plenums 320. In the exemplary embodiment, tube 204 includes four apertures 352 between first intermediate flange 312 and second intermediate flange 314, and four apertures 352 between second intermediate flange 314 and fore plate flange 316. Apertures 352 extend in a radial direction substantially orthogonal to longitudinal axis 303, and are equally spaced about a circumference of tube 204 in the exemplary embodiment. Alternatively, tube 204 may have any number and/or orientation of apertures 352 that enables tube assembly 202 to function as described herein.

In the exemplary embodiment, fuel is channeled through fuel delivery pipes 208 (shown in FIG. 2), and fuel is channeled through one or more plenums 320 from fluid delivery pipes 208 into fluid passage 350 via one or more apertures 352 defined in tube 204. Accordingly, apertures 352 facilitate mixing fuel from plenums 320 with air in fluid passage 350 from fluid supply chamber 232. Alternatively, any fluid may be channeled through tube passages 350 and/or plenums 320 that enables tube assembly 202 to function as described herein. In some embodiments, different fuels may be channeled through different sets of tubes 204. Further, in at least some embodiments, one or more apertures 360 are defined through flanges 304, facilitating fluid communication between plenums 320, fluid supply chamber 232, and/or combustion chamber 234.

To form tube assembly 202, in the exemplary embodiment, tube assembly units 300 are positioned adjacent to one another, such as in the configuration shown in FIG. 3, and flanges 304 of adjacent tube assembly units 300 are brazed and/or welded to one another. At least some flanges 304, such as fore plate flanges 316, are brazed and/or welded to wall fringes, such as fore plate fringe 330. Alternatively, tube assembly units 300 may be manufactured with precise dimensions/tolerances such that adjacent flanges 304 and/or fore plate fringe 330 fit together snugly in tube assembly 202, and need not be brazed and/or welded to one another to form tube assembly 202.

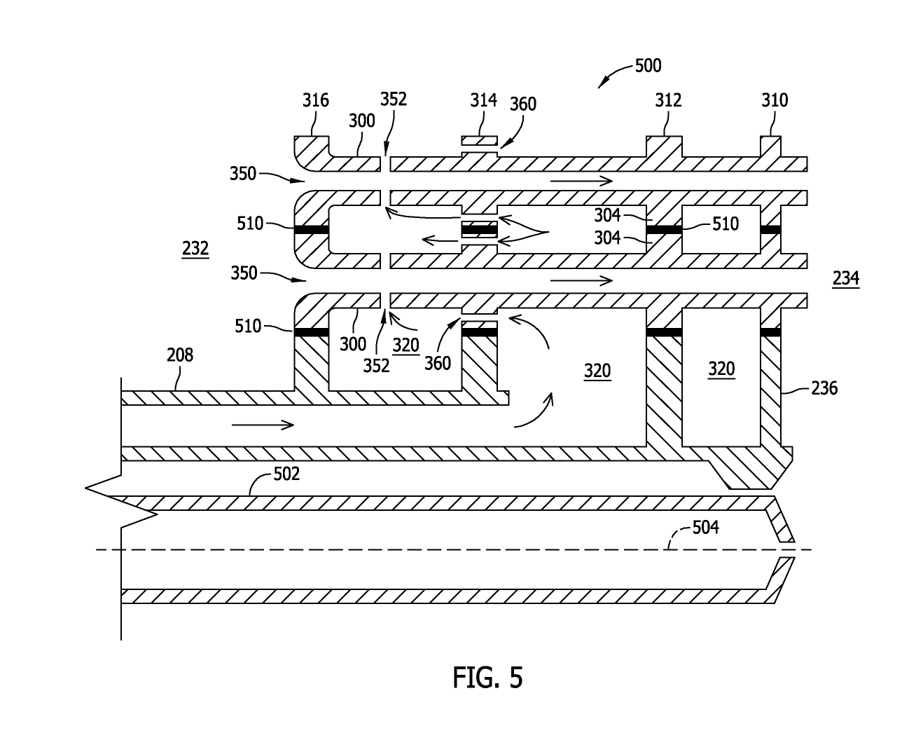

FIG. 5 is a cross-sectional view of a portion of an alternative tube assembly 500. Tube assembly 500 operates substantially similar to tube assembly 202 (shown in FIG. 3), and like reference numerals are used to designate like elements. Unlike tube assembly 202, tube assembly 500 includes an oil cartridge 502 that extends through tube assembly 500 along a centerline axis 504 of tube assembly 500. Oil cartridge 502 extends substantially parallel to tube assembly units 300.

In operation, fuel from fuel delivery pipe 208 flows into the plenum 320 between first intermediate flange 312 and second intermediate flange 314. The fuel then flows through apertures 360 in second intermediate flange 314 into the plenum 320 between second intermediate flange 314 and fore plate flange 316. Air from fluid supply chamber 232 flows through fluid passages 350 in tube assembly units 300, and fuel flows through apertures 352 to mix with the air in fluid passages 350. As shown in FIG. 5, flanges 304 of tube assembly units 300 are coupled to one another at brazes 510, or welds. In the embodiment shown in FIG. 5, the plenum 320 between first intermediate flange 312 and aft plate flange 310 includes air to facilitate cooling aft plate 236. In some embodiments, aft plate 236 includes one or more apertures defined therethrough (not shown) to enable flow communication between combustion chamber 234 and the aft-most plenum 320.

In the exemplary embodiment, each tube assembly unit 300 is formed from a single piece of material. For example, a component having a hexagonal outer diameter can be machined to remove a majority of the outer material to create the tube 204, while leaving a plurality of flanges 304 having the same shape as the hexagonal outer diameter. Accordingly, flanges 304 are formed integrally with tubes 204 in the exemplary embodiment. Alternatively, flanges 304 may be separate components coupled to tubes 204 using brazing and/or welding methods.

As compared to known tube assemblies, the systems described herein are relatively efficient and simple to assemble. Unlike at least some known tube assemblies, in which individual tubes must be aligned and welded to one or more plenum walls, the tube assembly units described herein include flanges that form plenum walls when the tube assembly units are positioned adjacent to each other. Further, unlike at least some known tube assemblies, by modifying the spacing between flanges on the tube assembly units, the size of plenums in the tube assemblies can be modified relatively quickly without substantial difficulty.

The embodiments described herein provide a tube assembly for use with a fuel injection assembly of a gas turbine engine. The tube assembly is formed from a housing and a plurality of tube assembly units. Each tube assembly unit includes a tube and a plurality of flanges. By positioning tube assembly units adjacent to each other, the flanges form at least a portion of a wall that defines plenums within the tube assembly.

Exemplary embodiments of systems and methods for tube assemblies are described above in detail. The systems and methods described herein are not limited to the specific embodiments described herein, but rather, components of the systems and/or steps of the methods may be utilized independently and separately from other components and/or steps described herein.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A tube assembly for use in a fuel injection assembly of a turbine engine, said tube assembly comprising:
a housing; and
a plurality of tube assembly units positioned adjacent to one another within said housing such that each tube assembly extends along a longitudinal axis of said housing, each tube assembly unit comprises:
a tube; and
a plurality of flanges extending radially outward from each said tube, wherein flanges of adjacent tube assembly units form at least a portion of at least one wall within said housing.

2. A tube assembly in accordance with claim 1, further comprising a wall fringe extending from said housing, said wall fringe oriented to form at least a portion of said at least one wall.

3. A tube assembly in accordance with claim 1, wherein flanges of adjacent tube assembly units form at least a portion of at least one of a fore plate and an aft plate of said tube assembly.

4. A tube assembly in accordance with claim 1, wherein at least one of said plurality of tube assembly units further comprises at least one aperture defined in said tube.

5. A tube assembly in accordance with claim 1, wherein at least one of said plurality of tube assembly units further comprises at least one aperture defined through at least one of said plurality of flanges.

6. A tube assembly in accordance with claim 1, wherein at least one of said plurality of flanges is hexagonal.

7. A tube assembly in accordance with claim 1, wherein said plurality of tube assembly units are brazed to one another to form at least a portion of said at least one wall.

8. A tube assembly in accordance with claim 1, wherein said housing is hexagonal.

9. A tube assembly unit for use in a fuel injection assembly of a turbine engine, said tube assembly unit comprising:
a tube; and
a plurality of flanges extending radially outward from said tube, wherein said plurality of flanges are configured to form at least a portion of at least one wall with flanges of adjacent tube assembly units.

10. A tube assembly unit in accordance with claim 9, wherein said plurality of flanges are configured to form at least a portion of at least one of a fore plate and an aft plate of a tube assembly.

11. A tube assembly unit in accordance with claim 9, further comprising at least one aperture defined in said tube.

12. A tube assembly unit in accordance with claim 9, further comprising at least one aperture defined through at least one of said plurality of flanges.

13. A tube assembly unit in accordance with claim 9, wherein at least one of said plurality of flanges is hexagonal.

14. A method of assembling a tube assembly for use in a fuel injection assembly of a turbine engine, said method comprising:
providing a housing; and
positioning a plurality of tube assembly units adjacent to one another within the housing such that each tube assembly extends along a longitudinal axis of the housing, each tube assembly unit including a tube and a plurality of flanges extending radially outward from each tube, wherein flanges of adjacent tube assembly units form at least a portion of at least one wall within the housing.

15. A method in accordance with claim 14, further comprising brazing flanges of adjacent tube assembly units to one another to form at least a portion of the at least one wall.

16. A method in accordance with claim 14, further comprising forming the at least one wall from flanges of adjacent tube assembly units and a wall fringe extending from the housing.

17. A method in accordance with claim 16, further comprising brazing at least one of the plurality of tube assembly units to the wall fringe.

18. A method in accordance with claim 14, wherein positioning a plurality of tube assembly units comprises positioning a plurality of tube assembly units including hexagonal flanges.

19. A method in accordance with claim 14, wherein providing a housing comprises providing a hexagonal housing.

20. A method in accordance with claim 14, wherein positioning the plurality of tube assembly units comprises positioning the plurality of tube assembly units such that flanges of adjacent tube assembly units form at least a portion of at least one of a fore plate and an aft plate of the tube assembly.
